(19) United States
(12) Patent Application Publication
(10) Pub. No.: US 2011/0227004 A1
(43) Pub. Date: Sep. 22, 2011

(54) PASTE FOR SOLAR CELL ELECTRODE AND SOLAR CELL USING THE SAME

(76) Inventors: Seok Hyun JUNG, Uiwang-si (KR); Dong Jun Kim, Uiwang-si (KR); Jae Hwan Oh, Uiwang-si (KR)

(21) Appl. No.: 13/036,646

(22) Filed: Feb. 28, 2011

(30) Foreign Application Priority Data
Mar. 19, 2010 (KR) 10-2010-0024962

(51) Int. Cl. H01B 1/12

(52) U.S. Cl. 252/513; 252/500; 252/514; 252/515; 252/512; 252/519.3

(57) ABSTRACT

A paste for solar cell electrodes includes a conductive powder, a glass frit, the glass frit including a crystallized glass frit, and an organic vehicle.

### BACKGROUND

1. Field

Embodiments relate to a paste for a solar cell electrode, a solar cell electrode, and a solar cell using the same.

2. Description of the Related Art

As fossil fuels such as oil and coal are expected to be exhausted, solar cells utilizing sunlight as an alternative energy source have attracted attention. A solar cell is formed to generate electric energy using the photovoltaic effect of a p-n junction which converts photons of sunlight into electricity. In the solar cell, a front electrode and a rear electrode are formed on upper and lower surfaces of a semiconductor wafer or substrate with the p-n junction, respectively. Then, the photovoltaic effect of the p-n junction is induced by sunlight entering the wafer and electrons generated by the photovoltaic effect of the p-n junction provide an electric current flowing to the outside through the electrodes.

### SUMMARY

An embodiment is directed a paste for solar cell electrodes, including a conductive powder, a glass frit, the glass frit including a crystallized glass frit, and an organic vehicle.

The conductive powder may include one or more of silver, gold, palladium, platinum, copper, chromium, cobalt, aluminum, tin, lead, zinc, iron, iridium, osmium, rhodium, tungsten, molybdenum, nickel, and indium tin oxide.

The crystallized glass frit may have a crystallization degree of about 5% to about 80%.

The crystallized glass frit may have a crystallization temperature of about 400° C. to about 700° C.

The glass frit may include the crystallized glass frit and an amorphous glass frit.

A mixing ratio of the crystallized glass frit to the amorphous glass frit may be about 30:70 to about 70:30 (w/w) in the glass frit.

The organic vehicle may include an organic binder and a solvent.

The paste may include about 50 wt % to about 90 wt % of the conductive powder, about 0.5 wt % to about 20 wt % of the glass fit, and about 1 wt % to about 30 wt % of the organic vehicle.

The paste may further include about 0.01 wt % to about 10 wt %, with respect to a total weight of the paste, of least one metal oxide selected from zinc oxide, lead oxide, and copper oxide.

The paste may further include at least one additive selected from the group of a plasticizer, a dispersant, a thixotropic agent, a viscosity stabilizer, an anti-foaming agent, a pigment, a UV stabilizer, an antioxidant, and a coupling agent.

Another embodiment is directed to a solar cell electrode formed of a paste according to an embodiment.

Another embodiment is directed to a solar cell including an electrode according to an embodiment.

### BRIEF DESCRIPTION OF THE DRAWING

The above and other features and advantages will become more apparent to those of skill in the art by describing in detail example embodiments with reference to the attached drawing, in which:

FIG. 1 illustrates a view of a solar cell according to an embodiment.

### DETAILED DESCRIPTION

Korean Patent Application No. 10-2010-0024962, filed on Mar. 19, 2010, in the Korean Intellectual Property Office, and entitled: “Paste for Solar Cell Electrode and Solar Cell Using the Same,” is incorporated by reference herein in its entirety.

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing FIGURE, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

According to an embodiment, a paste for solar cell electrodes includes (a) conductive powder, (b) a glass frit, and (c) an organic vehicle. An electrode may be formed by burning or sintering the paste for solar cell electrodes.

(a) Conductive Powder

The conductive powder may be a conductive organic material or a conductive inorganic material. Examples of the conductive powder may include, but are not limited to, silver (Ag), gold (Au), palladium (Pd), platinum (Pt), copper (Cu), chromium (Cr), cobalt (Co), aluminum (Al), tin (Sn), lead (Pb), zinc (Zn), iron (Fe), iridium (Ir), osmium (Os), rhodium (Rh), tungsten (W), molybdenum (Mo), nickel (Ni), and indium tin oxide (ITO). These conductive powders may be used alone or in a combination of two or more kinds thereof. In an embodiment, the conductive powder includes silver (Ag) particles, and may further include nickel (Ni), cobalt (Co), iron (Fe), zinc (Zn), or copper (Cu) particles.

The conductive powder may have an average particle diameter (D50) of about 0.1 μm to about 10 μm, preferably about 0.2 μm to about 7 μm, more preferably about 0.5 μm to about 5 μm, and still more preferably about 1 μm to about 3 μm.

The conductive powder may be included in an amount of about 50 to about 90 wt % with respect to a total weight of the paste. Such an amount may provide an electrode with good series resistance (Rs) and fill factor (FF) without suffering short circuit of the electrode, and a paste may be easily formed within the above range. The conductive powder may be added preferably in an amount of about 70 wt % to about 85 wt % with respect to a total weight of the paste.

(b) Glass Frit

The glass frit may etch an anti-reflection film on a front surface during a burning process. The glass frit may permit good ohmic contact between the conductive powder and a silicon wafer having a p-n junction, and may enhance adhesion between the conductive powder and a lower matrix.

The glass frit may include a crystallized glass fit. In an embodiment, the glass frit may include only the crystallized glass frit. In another embodiment, the glass frit may include the crystallized glass frit and an amorphous glass frit. When the glass frit includes both the crystallized glass frit and the amorphous glass frit, the mixing ratio of crystallized glass fit to amorphous glass frit may be about 30:70 to about 70:30 (w/w), and preferably about 40:60 to about 60:40 (w/w), in the glass frit.

In an embodiment, the glass frit may include bismuth oxide (Bi₂O₃) as a main component, and may further include barium carbonate (BaCO₃), boron oxide (B₂O₃), zinc oxide (ZnO), and the like.

The crystallized glass frit may have a crystallization degree of about 5% to about 80% at about 400° C. to about 700° C. With the crystallized glass frit in this range, good ohmic contact may be obtained and cracks may not be formed even after sintering. In an embodiment, the crystallized glass frit may have a crystallization degree of about 20 to about 80%, preferably about 25 to about 75%, and more preferably about 40 to about 70%.

The crystallized glass frit may have a crystallization temperature T_{C} of about 400° C. to about 700° C. The crystallization temperature T_{C} may be determined by differential scanning calorimetry (DSC) or differential thermal analysis (DTA).

Further, the crystallized glass frit may have a softening temperature of about 300° C. to about 500° C., and a transition point of about 250° C. to about 450° C. Preferably, the glass frit has a transition point of about 300° C. to about 400° C.

The glass frit (b) may have an average particle diameter (D50) of about 0.1 μm to about 5 μm. With the glass frit in the range, failures may be avoided during printing when forming the electrode, and good pattern compactness may be obtained after sintering, thereby lowering resistance loss.

The glass frit may be included in an amount of about 0.5 wt % to about 20 wt % with respect to the total weight of the paste. Such an amount may avoid a failure in etching of the anti-reflection film and ohmic contact, and prevent breakdown of the p-n junction and an increase in resistance. The glass frit is preferably included in an amount of about 1 wt % to about 15 wt %, and more preferably about 2 wt % to about 10 wt %, with respect to the total weight of the paste.

(c) Organic Vehicle

The organic vehicle (c) may act as a liquid carrier and may be, or may include, an organic binder which provides liquid properties to the paste, and may further include a solvent.

As the organic binder, cellulose polymers, such as ethyl cellulose, hydroxyethyl cellulose, hydroxypropyl cellulose, and hydroxyethyl hydroxypropyl cellulose, as well as acrylic polymers may be used alone or in a mixture of two or more kinds thereof.

The solvent may be an organic solvent having a boiling point of about 120° C. or more. Examples of the solvent may include, but are not limited to, methyl cellosolve, ethyl cellosolve, butyl cellosolve, aliphatic alcohol, terpineol, ethylene glycol, ethylene glycol mono butyl ether, butyl cellosolve acetate, and texanol. These solvents may be used alone or in a mixture of two or more kinds thereof.

In an embodiment, the organic vehicle (c) may include about 5 wt % to about 30 wt % of the organic binder and about 70 wt % to about 95 wt % of the solvent. In another embodiment, the organic vehicle (c) may include about 10 wt % to about 20 wt % of the organic binder and about 80 wt % to about 90 wt % of the solvent.

The organic vehicle may be included in an amount of about 1 wt % to about 30 wt % with respect to the total weight of the paste. In an embodiment, the organic vehicle may be included in an amount of about 1 wt % to about 25 wt %. Preferably, the organic vehicle is included in an amount of about 5 wt % to about 20 wt %. Maintaining the content of organic vehicle at about 1 wt % or more may help avoid undue viscosity increase after the preparation of the paste, and may help avoid deterioration of adhesion to the substrate after printing and drying the paste. Maintaining the content of organic vehicle at about 30 wt % or less may help prevent the solar cell from having a decreased surface area receiving sunlight, such decrease causing a reduction in photoelectron-motive force.

(d) Metal Oxide

The paste for solar cell electrodes may further include at least one metal oxide. For example, one or more of zinc oxide (ZnO), lead oxide (PbO), and copper oxide (CuO) may be included.

The metal oxide (d) may have an average particle diameter (D50) of about 0.1 μm to about 25 μm, and preferably about 1.5 μm to about 10 μm.

The metal oxide (d) may improve contact resistance of the electrode and facilitates crystallization of the glass frit. The metal oxide may be included in an amount of about 0.01 wt % to about 10 wt % with respect to the total weight of the paste. Preferably, the metal oxide is included in an amount of about 0.5 wt % to about 7 wt %, and more preferably about 0.1 wt % to about 5 wt %.

If the metal oxide is added in an amount of about 10 wt % or less, deterioration in sintering compactness of the electrode pattern may be avoided, thereby avoiding a resistance increase and deterioration in electrical properties of the solar cell.

The paste for solar cell electrodes may further include general additives, as desired, e.g., to enhance flow properties, process properties, and stability. The additives may include, but are not limited to, a plasticizer, a dispersant, a thixotropic agent, a viscosity stabilizer, an anti-foaming agent, a pigment, a UV stabilizer, an antioxidant, a coupling agent, etc. These substances may be used alone or in a mixture of two or more kinds thereof.

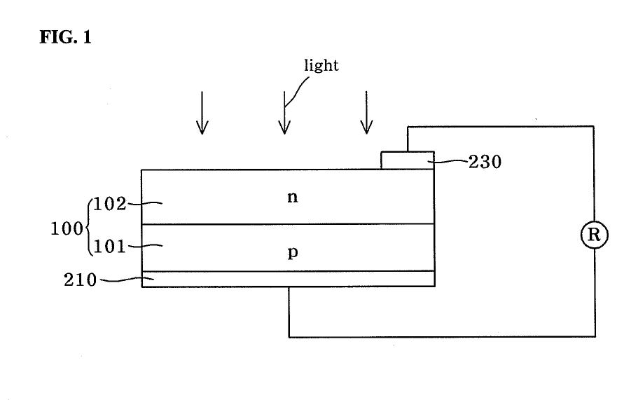

Another embodiment is directed to an electrode formed of the paste for solar cell electrodes and a solar cell including the same. FIG. 1 illustrates a solar cell according to an embodiment.

Referring to FIG. 1, a rear electrode 210 and a front electrode 230 may be formed by printing and burning the paste according to an embodiment on a wafer or substrate 100, the substrate 100 including a p-layer 101 and an n-layer 102, which will serve as an emitter. For example, a preliminary process for preparing the rear electrode 210 may be performed by printing the paste on a rear surface of the wafer 100 and drying the printed paste at about 200° C. to about 400° C. for about 10 to 60 seconds. Further, a preliminary process for preparing the front electrode 230 may be performed by printing the paste on a front surface of the wafer 100 and drying the printed paste. Then, the front electrode 230 and the rear electrode 210 may be formed by burning the wafer 100 at about 400° C. to about 900° C. for about 30 to 50 seconds.

The following Examples and Comparative Examples are provided in order to set forth particular details of one or more embodiments. However, it will be understood that the embodiments are not limited to the particular details described. Further, the Comparative Examples are set forth to highlight certain characteristics of certain embodiments, and are not to be construed as either limiting the scope of the invention as exemplified in the Examples or as necessarily being outside the scope of the invention in every respect.

A description of details apparent to those skilled in the art may be omitted herein for clarity of description.

### EXAMPLES

Components are shown in Table 1. Specifications of components used in the following examples and comparative examples were as follows:

(a) Conductive powder: Spherical Ag powder having an average particle diameter (D50) of 2 μm (AG-4-8, Dowa HighTech Co., Ltd.);

(b) Glass frit:

(b1) Crystallized lead-free glass frit having an average particle diameter of 0.9 μm and a transition point of 365° C. (Crystallized Glass, crystallization degree 28.2%, Yamamura Co., Ltd., BT328);

(b2) Amorphous leaded glass frit having an average particle diameter of 1 μm and a transition point of 451° C. (Leaded Glass, Particlogy Co., Ltd., PSL1004C);

(b3) Amorphous lead-free glass frit having an average particle diameter of 2.2 μm and a transition point of 421° C. (Lead-free Glass, Particlogy Co., Ltd., LF6001).

(c) Organic vehicle:

(c1) Binder: Ethyl cellulose (Dow Chemical Co., Ltd., STD4);

(c2) Solvent: Terpineol (Nippon Terpine Co., Ltd.).

(d) Metal oxide: ZnO powder (Kanto Chemical Co., Ltd.).

### Example 1

2 wt % ethyl cellulose was sufficiently dissolved in 15 wt % of terpineol at 60° C., and 80 wt % of Ag powder and 3 wt % of the crystallized glass frit (b1) were added thereto and uniformly mixed with the solution, followed by mixing and dispersing via a 3-roll mixer to obtain a paste for solar cell electrodes.

### Example 2

Example 2 was carried out by the same process as in Example 1, except for using 2 wt % of the crystallized glass frit (b1) and further adding 1 wt % of ZnO powder.

### Example 3

Example 3 was carried out by the same process as in Example 2, except for further adding 2 wt % of the amorphous leaded glass frit (b2) and using 13 wt % of terpineol.

### Example 4

Example 4 was carried out by the same process as in Example 3 except for using 2 wt % of the amorphous lead-free glass fit (b3) instead of the amorphous leaded glass frit (b2).

### Example 5

Example 5 was carried out by the same process as in Example 1 except for using 4 wt % of the crystallized glass frit (b1) and using 13 wt % of terpineol, and further adding 1 wt % of ZnO powder.

### Example 6

Example 6 was carried out by the same process as in Example 3 except for using 4 wt % of ZnO powder and 10 wt % of terpineol.

### Comparative Example 1

Comparative Example 1 was carried out by the same process as in Example 1 except for using 3 wt % of the amorphous leaded glass frit (b2) instead of the crystallized glass frit (b1).

### Comparative Example 2

Comparative Example 2 was carried out by the same process as in Example 2 except for using 2 wt % of the amorphous leaded glass fit (b2) instead of the crystallized glass frit (b1).

Each of the pastes prepared by Examples 1 to 6 and Comparative Examples 1 and 2 was printed in a predetermined pattern on an overall front surface of a wafer by screen printing, and dried in a UV drying furnace. An aluminum paste was then printed on an overall rear surface of the wafer by screen printing, and dried in the same manner. The wafer was burned at 400 to 900° C. for 30˜50 seconds in a belt-type drying furnace, thereby preparing a solar cell. Series resistance (Rs, Ω), parallel resistance (Rsh, Ω), and conversion efficiency (Eff., %) of the solar cell were measured using a tester for solar cell efficiency (CT801, Pasan SA). The results are shown in Table 1.

TABLE 1

| | | | | | | | | Comparative | |
|---|---|---|---|---|---|---|---|---|---|
| | | Example | | | | | | Example | |
| | | 1 | 2 | 3 | 4 | 5 | 6 | 1 | 2 |
| (a) Conductive | | 80 | 80 | 80 | 80 | 80 | 80 | 80 | 80 |
| powder (wt %) | | | | | | | | | |
| (b) Glass frit | (b1) | 3 | 2 | 2 | 2 | 4 | 2 | — | — |
| (wt %) | (b2) | — | — | 2 | — | — | 2 | 3 | 2 |
| | (b3) | — | — | — | 2 | — | — | — | — |
| (c) Organic | (c1) | 2 | 2 | 2 | 2 | 2 | 2 | 2 | 2 |
| vehicle (wt %) | (c2) | 15 | 15 | 13 | 13 | 13 | 10 | 15 | 15 |

| | | | | | | | | |
|---|---|---|---|---|---|---|---|---|
| (d) ZnO (wt %) | — | 1 | 1 | 1 | 1 | 4 | — | 1 |
| Rs (mΩ) | 10.0 | 11.0 | 8.0 | 7.5 | 9.0 | 7.2 | 35.0 | 22.0 |
| Rsh (Ω) | 15.3 | 8.1 | 22.0 | 31.1 | 13.1 | 32.7 | 0.2 | 1.1 |
| Conversion efficiency | 16.0 | 15.9 | 16.8 | 16.9 | 16.3 | 17.4 | 11.2 | 12.3 |
| (%) | | | | | | | | |

As shown in Table 1, Examples 1 to 6, in which the crystallized glass fit was added, exhibited good conversion efficiency. Also, when the metal oxide was added to the paste, superior improvement in series resistance was realized, thereby resulting in improved conversion efficiency.

As described above, embodiments relate to a paste for solar cell electrodes. The paste may include a conductive powder, a glass fit, and an organic vehicle, wherein the glass frit includes a crystallized glass frit. The crystallized glass frit in the paste may help provide significantly improved conversion efficiency. Embodiments also relate to solar cell using an electrode formed from the paste. The electrodes of the solar cell may be formed on a wafer by applying, patterning, and burning the paste for electrodes. The paste may be particularly suited for a front electrode among the solar cell electrodes, i.e., an electrode facing an incident direction of sunlight.

One criterion for evaluation of solar cell quality is conversion efficiency. The solar cell's conversion efficiency refers to the percentage of electrical energy converted from incident light and can be represented by the ratio of the maximum power to incident energy. In order to increase conversion efficiency of a solar cell, improvement in characteristics of electrodes is important. Efforts at developing solar cell components may include a method of determining tap density of Ag powder, a method of enhancing conversion efficiency by changing a composition of a glass fit, a method of changing a particle diameter of Ag powder, and a method of improving conversion efficiency using a sintering restrainer. However, Ag ions may infiltrate into a silicon wafer during sintering after printing and drying a solar cell paste on front and rear sides of the wafer, such that the prepared solar cell suffers deterioration in series and parallel resistance due to low distribution of ions on the electrode, whereby improvements in the conversion efficiency of the solar cell may be impaired. In contrast, embodiments provide a paste for solar cell electrodes and a solar cell using the same that may provide good series and parallel resistance while improving conversion efficiency.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A paste for solar cell electrodes, comprising:
a conductive powder;
a glass frit, said glass frit including a crystallized glass frit; and
an organic vehicle.

2. The paste as claimed in claim 1, wherein said conductive powder includes one or more of silver, gold, palladium, platinum, copper, chromium, cobalt, aluminum, tin, lead, zinc, iron, iridium, osmium, rhodium, tungsten, molybdenum, nickel, and indium tin oxide.

3. The paste as claimed in claim 1, wherein said crystallized glass frit has a crystallization degree of about 5% to about 80%.

4. The paste as claimed in claim 1, wherein said crystallized glass frit has a crystallization temperature of about 400° C. to about 700° C.

5. The paste as claimed in claim 1, wherein said glass frit includes said crystallized glass frit and an amorphous glass frit.

6. The paste as claimed in claim 5, wherein a mixing ratio of said crystallized glass frit to said amorphous glass frit is about 30:70 to about 70:30 (w/w) in said glass frit.

7. The paste as claimed in claim 1, wherein said organic vehicle includes an organic binder and a solvent.

8. The paste as claimed in claim 1, wherein said paste comprises about 50 wt % to about 90 wt % of said conductive powder, about 0.5 wt % to about 20 wt % of said glass fit, and about 1 wt % to about 30 wt % of said organic vehicle.

9. The paste as claimed in claim 1, further comprising about 0.01 wt % to about 10 wt %, with respect to a total weight of the paste, of least one metal oxide selected from zinc oxide, lead oxide, and copper oxide.

10. The paste as claimed in claim 1, further comprising at least one additive selected from the group of a plasticizer, a dispersant, a thixotropic agent, a viscosity stabilizer, an anti-foaming agent, a pigment, a UV stabilizer, an antioxidant, and a coupling agent.

11. A solar cell electrode formed of the paste as claimed in claim 1.

12. A solar cell comprising the electrode as claimed in claim 11.
